(19) United States
(12) Patent Application Publication
(10) Pub. No.: US 2010/0197038 A1
(43) Pub. Date: Aug. 5, 2010

(54) MICROELECTRONIC SENSOR DEVICE FOR OPTICAL EXAMINATIONS WITH TOTAL INTERNAL REFLECTION

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/669,844

(22) PCT Filed: Jul. 21, 2008
(86) PCT No.: PCT/IB2008/052926

§ 371 Date: Jan. 20, 2010

(30) Foreign Application Priority Data
Jul. 26, 2007 (EP) 07113174.2

(51) Int. Cl. G01N 21/75

(52) U.S. Cl. 436/164; 422/82.05

(57) ABSTRACT

The invention relates to a microelectronic sensor device for optical examinations like the detection of target components that comprise label particles (1), for example magnetic particles (1). An input light beam (L1) is transmitted into a carrier (111) and totally internally reflected at a binding surface (112) to yield a “TIR-beam of first order” (L_{TIR}(1)), which is redirected by a mirroring system (e.g. reflective 5 facets (114)) to the binding surface (112), where it is again totally internally reflected as a “TIR-beam of second order” (L_{TIR}(2)), and so on. Finally, an output light beam (L2) comprising light of the “TIR-beam of (N+1)-th order”, with a given natural number N, leaves the carrier to be detected by a light detector (31).

The invention relates to a microelectronic sensor device and a method for making optical examinations at a binding surface of a carrier, particularly for the detection of target components like biological molecules comprising label particles. Moreover, it relates to a carrier for such a device.

The US 2005/0048599 A1 discloses a method for the investigation of microorganisms that are tagged with particles such that a (e.g. magnetic) force can be exerted on them. In one embodiment of this method, a light beam is directed one times or several times through a transparent material to a surface where it is totally internally reflected. Light of this beam that leaves the transparent material as an evanescent wave is scattered by microorganisms and/or other components at the surface and then detected by a photodetector or used to illuminate the microorganisms for visual observation. A problem of these and similar measurement devices is that the signal one is interested in is often very small in comparison to a large baseline signal, which makes accurate measurements difficult.

Based on this situation it was an object of the present invention to provide means that allow for an improved optical examination at the binding surface of carrier, particularly under operating conditions that comprise only small variations of a large baseline signal.

This object is achieved by a microelectronic sensor device according to claim 1, a carrier according to claim 5, and a method according to claim 11. Preferred embodiments are disclosed in the dependent claims.

The microelectronic sensor device according to the present invention is intended for making optical examinations at the binding surface of a carrier, wherein said carrier does not necessarily belong to the device. In this context, the term “examination” is to be understood and a broad sense, comprising any kind of manipulation and/or interaction of light with some entity at the binding surface, for example with biological molecules to be detected.

The term “binding surface” is chosen primarily as a unique reference to a particular part of the surface of the carrier, and though target components will in many applications actually bind to said surface, this does not necessarily need to be the case. Furthermore, the binding surface will usually be planar, though it may in general also have a curved shape or comprise multiple facets.

The examinations may preferably comprise the qualitative or quantitative detection of target components comprising label particles, wherein the target components may for example be biological substances like biomolecules, complexes, cell fractions or cells. The term “label particle” shall denote a particle (atom, molecule, complex, nanoparticle, microparticle etc.) that has some property (e.g. optical density, magnetic susceptibility, electrical charge, fluorescence, radioactivity, etc.) which can be detected, thus indirectly revealing the presence of the associated target component. The “target component” and the “label particle” may optionally also be identical.

The microelectronic sensor device comprises the following components:
a) A light source for emitting a light beam, called “input light beam” in the following, towards the binding surface of the carrier, wherein said input light beam is totally internally reflected at the binding surface and wherein the resulting reflected light beam will be called “TIR-beam of first order” in the following. The light source may for example be a laser or a light emitting diode (LED), optionally provided with some optics for shaping and directing the input light beam.
It should be noted that the binding surface must be an interface between two media, e.g. glass and water, at which total internal reflection (TIR) can take place if an incident light beam hits the interface at an appropriate angle (larger than the associated critical angle of TIR). Such a setup is often used to examine small volumes of a sample at the TIR-interface which are reached by exponentially decaying evanescent waves of the totally internally reflected beam. Target components—e.g. atoms, ions, (bio-)molecules, cells, viruses, or fractions of cells or viruses, tissue extract, etc.—that are present in the investigation region can then scatter the light of the evanescent waves which will accordingly miss in the reflected light beam. In this scenario of a “frustrated total internal reflection” (as a special case of TIR), the output light beam of the sensor device will comprise the reflected light of the input light beam, wherein the small amount of light missing due to scattering of evanescent waves contains the desired information about the target components in the investigation region.
b) A “mirroring system” for redirecting a TIR-beam of n-th order towards the binding surface, from which said TIR-beam is totally internally reflected as a so-called “TIR-beam of (n+1)-th order”, wherein the natural number n ranges between 1 and a given upper natural number N. The redirection of the TIR-beam of n-th order may be achieved by any suitable principle, e.g. refraction, TIR, diffraction, and, most of all, reflection. Thus the term “mirroring system” shall in a general sense refer to the function of light-redirection and shall not be limited to a particular way (e.g. specular reflection) by which this redirection is achieved. Moreover, at least parts of the mirroring system may be disposed outside or inside the carrier.

For the most simple case of N=1, the TIR-beam of first order that stems from the total internal reflection of the input light beam is redirected once by the mirroring system towards the binding surface, where it is (again) totally internally reflected, now as a TIR-beam of second order. For higher values of N, this process is repeated several times. Moreover, it can be concluded that a “TIR-beam of n-th order” denotes by definition a light beam just after a total internal reflection, wherein said light beam goes back to the input light beam after n total internal reflections.
c) A light detector for detecting an output light beam which comprises light of the TIR-beam of (N+1)-th order. The detection of the output light beam typically comprises the determination of a characteristic parameter of the output light beam, particularly the amount of light in this beam (e.g. expressed by its intensity). In practice, the output light beam will not comprise the whole light of the TIR-beam of (N+1)-th order, as some of this light will usually be lost due to scattering etc. Similarly, the output light beam will typically comprise also light from other sources, e.g. scattered light or light of (stimulated) fluorescence of particles at the binding surface.
The light of the TIR-beam of (N+1)-th order is often the signal one is interested in, as it carries desired information about the conditions at the binding surface.

The described microelectronic sensor device has the advantage to make use of several (at least two) total internal reflections of an input light beam at the binding surface. The effects that are associated to the total internal reflection will therefore be multiplied accordingly. If the effect is for example a frustrated total internal reflection (FTIR) at the binding surface, wherein the degree of frustration is correlated to the amount of target particles/labels one is interested in, then the repeated FTIR leads to an accumulation of the frustration effect.

In a preferred embodiment of the microelectronic sensor device, the input light beam and the TIR-beams of n-th order (1≦n≦N) are totally internally reflected in at least one investigation region at the binding surface under similar conditions, particularly in a similar chemical environment. The investigation regions will typically comprise a small volume at the binding surface in which material of a sample to be examined can be provided. In general, the output light beam that is finally detected comprises only information about the average conditions at the binding surface. If the conditions in all relevant investigation regions are however similar (including the case of being identical), then these conditions can exactly be derived from the output light beam. The similarity of operating conditions may particularly comprise an identical coating with binding sites throughout the whole binding surface.

As was already mentioned, the microelectronic sensor device may be used for a qualitative detection of target components, yielding for example a simple binary response with respect to a particular target molecule (“present” or “not-present”). Preferably the sensor device comprises however an evaluation module for quantitatively determining the amount of target components at the binding surface from the detected output light beam. This can for example be based on the fact that the amount of light in an evanescent light wave, that is absorbed or scattered by target components, is proportional to the concentration of these target components in the corresponding investigation region. The amount of target components in the investigation region may in turn be indicative of the concentration of these components in an adjacent sample fluid according to the kinetics of the related binding processes.

In another embodiment of the invention, the light source is adapted to provide a plurality of input light beams, preferably input light beams that propagate substantially in parallel. In this case, different investigation regions at the binding surface can be examined in parallel, which allows for example the search for different target components, the observation of the same target components under different conditions and/or the sampling of several measurements for statistical purposes.

The invention further relates to a carrier for optical examinations, particularly a carrier that is suited for a use together with a microelectronic sensor device of the kind described above. The carrier will usually be made from a transparent material, for example poly-styrene, to allow the propagation of light of a given (visible) spectrum, and comprises the following components:
a) An “entrance window” through which an input light beam can enter the carrier. The entrance window will typically be a planar or curved facet that is preferably oriented at a right angle with respect the input light beam. It may comprise an antireflection coating or other measures that minimize a reflection of the input light.
b) A “binding surface” at which the aforementioned input light beam can be totally internally reflected as a “TIR-beam of first order”.
c) At least one reflective facet from which a TIR-beam of n-th order is reflected back to the binding surface, where said TIR-beam of n-th order is totally internally reflected as a “TIR-beam of (n+1)-th order”, with n ranging from 1 to a given natural number N≧1. As usual, the term “facet” shall refer to a connected surface region which may be planar or curved, wherein this region typically comprises the whole smoothly bended area of the surface between a closed borderline defined by sharp bendings or edges.
d) An “exit window” through which an output light beam comprising light of the TIR-beam of (N+1)-th order can leave the carrier. The exit window will typically be a planar or curved facet that is preferably oriented at a right angle with respect the output light beam. It may comprise an antireflection coating or other measures that minimize a reflection of the output light.

As the described carrier is compatible with a microelectronic sensor device of the kind described above, reference is made to the preceding description of said device for more information about the details, advantages, and modifications of the carrier. It should be noted in this context that the reflective facet of the carrier is one important example for a “mirroring system”. In this case, the redirection of the light beam can take place inside the carrier which has the advantage to avoid possible disturbances of the beam outside the carrier.

As the carrier may optionally be treated as one component of the microelectronic sensor device described above, the embodiments of the carrier that will be explained in the following do also refer to said microelectronic sensor device. It should however be noted that the microelectronic sensor device does not necessarily comprise a carrier but may only be adapted for a use together with such a carrier. In practice, the carrier will usually be an exchangeable (disposable) part that is intended for a single use in a microelectronic sensor device.

The carrier (as a standalone device or as a component of the microelectronic sensor device) preferably comprises at least one facet that is slanted at an acute angle with respect to the binding surface and that is at least partially reflective. Due to its inclination with respect to the binding surface, said facet can reflect a TIR-beam (of first or higher order) coming from the binding surface back towards the binding surface for a further total internal reflection, provided that the geometry of the binding surface, the facet, and the input light beam are appropriately chosen. A particular advantage of the slanted reflective facets is that the TIR-regions where the light is totally internally reflected at the binding surface can be very close together, allowing a compact carrier design and approximately uniform conditions in the TIR-regions.

In a preferred embodiment of the aforementioned approach, the carrier comprises two such slanted facets that are arranged on opposite sides of the carrier. As will be explained in more detail with reference to the Figures, the facets can then repeatedly reflect a light beam back and forth, wherein said beam is each time totally internally reflected at the binding surface on its way from one facet to the other.

The carrier may also comprise three such slanted facets that are arranged in a U-shape. Light entering the carrier from a first side (the open top of the “U”) may then sequentially be reflected at all three segments of the “U” and leave the carrier again through the first side.

In still another embodiment, the carrier comprises four such slanted facets arranged as a rectangle, wherein at least one of these facets lies adjacent to the entrance window and the exit window. An input light beam entering through the entrance window may then travel several times around through the rectangle until it finally impinges on the exit window where it leaves the carrier.

The invention further relates to a method for optical examinations at the binding surface of a carrier, particularly for the detection of target components comprising label particles, comprising
a) emitting an input light beam towards the binding surface, from which said beam is totally internally reflected as a “TIR-beam of first order”;
b) redirecting a TIR-beam of n-th order towards the binding surface, from which said beam is totally internally reflected as a “TIR-beam of (n+1)-th order”, with n=1, . . . N for a given natural number N;
c) detecting an output light beam which comprises light of the TIR-beam of (N+1)-th order.

The method comprises in general form the steps that can be executed with a microelectronic sensor device of the kind described above. Therefore, reference is made to the preceding description for more information on the details, advantages and improvements of that method.

These and other aspects of the invention will be apparent from and elucidated with reference to the embodiment(s) described hereinafter. These embodiments will be described by way of example with the help of the accompanying drawings in which:

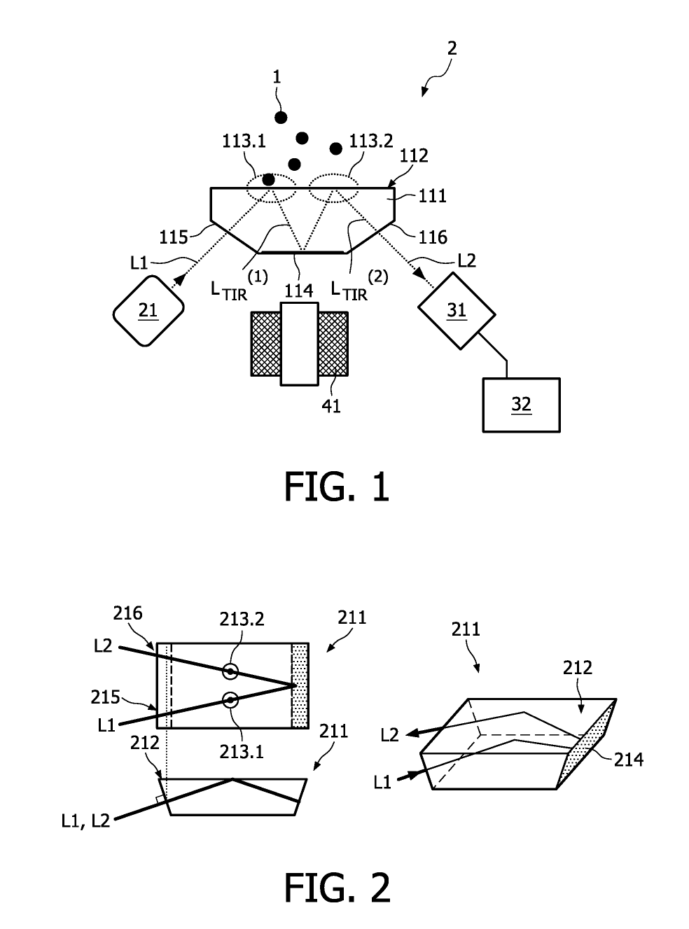

FIG. 1 schematically shows the general setup of a microelectronic sensor device according to the present invention;

FIG. 2 shows in a top view (top left), a side view (bottom left), and a perspective (right) a first embodiment of a carrier according to the present invention that is designed as a dovetail prism with one reflective facet;

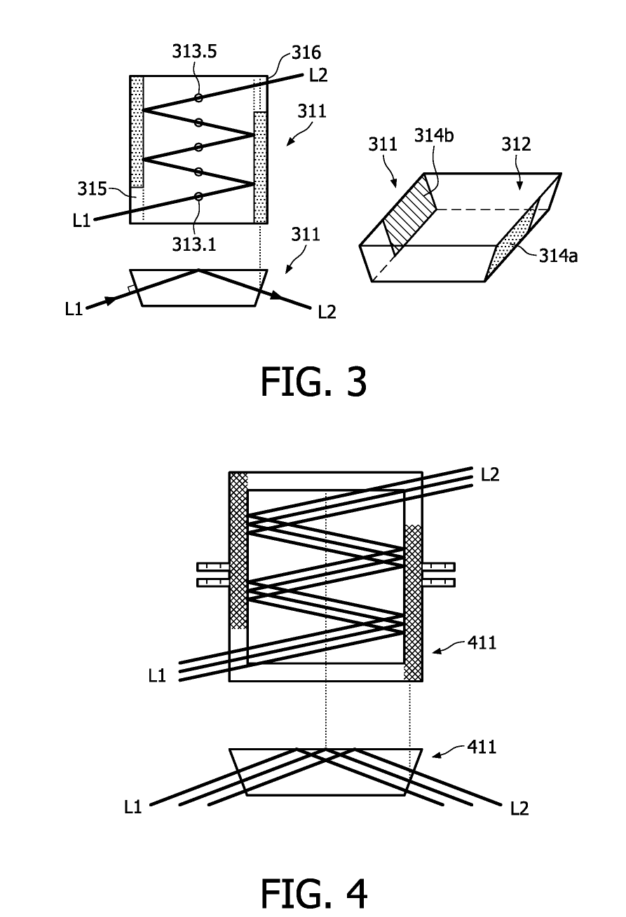

FIG. 3 shows a modification of the carrier of FIG. 2 in which two opposing facets are partially reflective;

FIG. 4 shows in a top view (top) and side view (bottom) the use of several parallel input light beams in the carrier of FIG. 3;

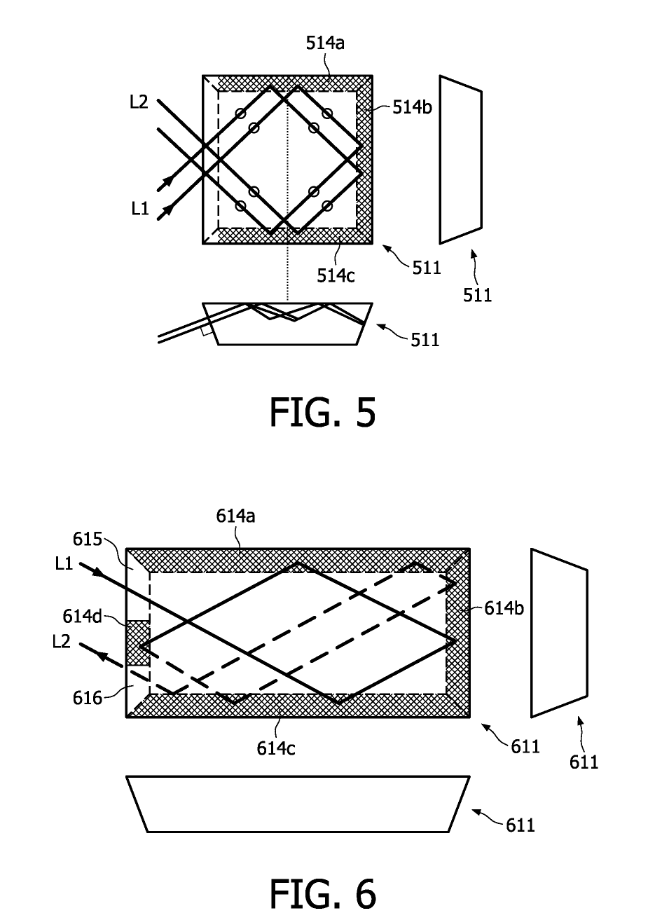

FIG. 5 shows in a top view (top) and two side views (bottom, right) another embodiment of a carrier according to the present invention with the general shape of a truncated pyramid with three reflective facets;

FIG. 6 shows a modification of the carrier of FIG. 5, wherein the shape is rectangular and wherein the forth side is partially reflective, too;

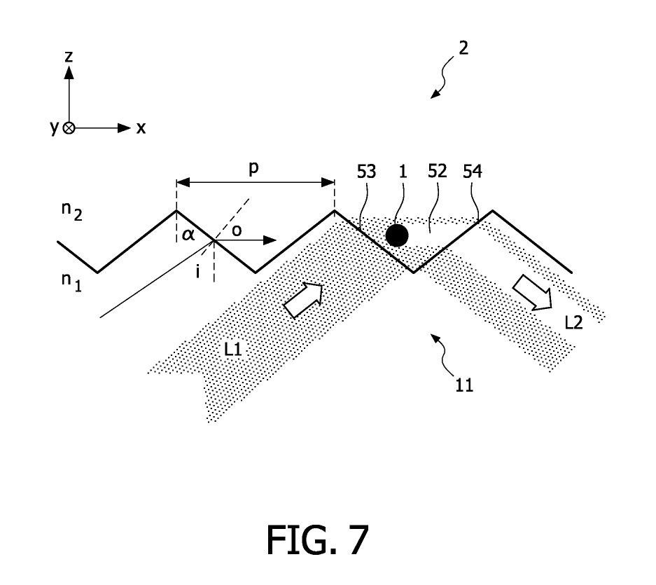

FIG. 7 shows an enlarged view of an alternative optical structure of the carrier.

Like reference numbers or numbers differing by integer multiples of 100 refer in the Figures to identical or similar components.

FIG. 1 shows a general setup with a microelectronic sensor device according to the present invention. A central component of this setup is the carrier 111 that may for example be made from glass or transparent plastic like poly-styrene. The carrier 111 is located next to a sample chamber 2 in which a sample fluid with target components to be detected (e.g. drugs, antibodies, DNA, etc.) can be provided. The sample further comprises magnetic particles 1, for example superparamagnetic beads, wherein these particles 1 are usually bound as labels to the aforementioned target components (for simplicity only the magnetic particles 1 are shown in the Figure). It should be noted that instead of magnetic particles other label particles, for example electrically charged or fluorescent particles, could be used as well.

The interface between the carrier 111 and the sample chamber 2 is formed by a surface called “binding surface” 112. This binding surface 112 may optionally be coated with capture elements, e.g. antibodies, which can specifically bind the target components.

The sensor device comprises a magnetic field generator 41, for example an electromagnet with a coil and a core, for controllably generating a magnetic field B at the binding surface 112 and in the adjacent space of the sample chamber 2. With the help of this magnetic field B, the magnetic particles 1 can be manipulated, i.e. be magnetized and particularly be moved (if magnetic fields with gradients are used). Thus it is for example possible to attract magnetic particles 1 to the binding surface 112 in order to accelerate the binding of the associated target component to said surface.

The sensor device further comprises a light source 21, for example a laser or an LED, that generates an input light beam L1 which is transmitted into the carrier 111 through an “entrance window” 115. The input light beam L1 arrives in a first “investigation region” 113.1 at the binding surface 112 at an angle larger than the critical angle θ_{c} of total internal reflection (TIR) and is therefore totally internally reflected in a “TIR-beam of first order” L_{TIR}⁽¹⁾. This TIR-beam of 1st order then impinges on a reflective bottom surface 114 of the carrier 111, where it is reflected back to a second investigation region 113.2 at the binding surface 112. At the binding surface 112, the TIR-beam of 1st order is once again totally internally reflected as a “TIR-beam of 2nd order” L_{TIR}⁽²⁾. In principle, further reflections at the reflective facet 114 and total internal reflections at the binding surface 112 could take place, finally yielding a “TIR-beam of (N+1)-th order” (for a given natural number N) that propagates towards an “exit window” 116. In the depicted example, the number N of back-reflections is N=1 for simplicity.

As already mentioned, the TIR-beam of 2nd order L_{TIR}⁽²⁾ leaves the carrier 111 through the exit window 116 as an “output light beam” L2. This output light beam L2 will typically comprise additional light components leaving the carrier, e.g. light of the input light beam that was scattered inside the carrier. The output light beam L2 is detected by a light detector 31. The light detector 31 determines the amount of light of the output light beam L2 (e.g. expressed by the light intensity of this light beam in the whole spectrum or a certain part of the spectrum). The measurement results are evaluated and optionally monitored over an observation period by an evaluation and recording module 32 that is coupled to the detector 31.

As light source 21, a commercial DVD (λ=658 nm) laser-diode can be used. A collimator lens may be used to make the input light beam L1 parallel, and a pinhole of e.g. 0.5 mm may be used to reduce the beam diameter.

It is possible to use the detector 31 also for the sampling of fluorescence light emitted by fluorescent particles 1 which were stimulated by the evanescent wave of the input light beam L1, wherein this fluorescence may for example spectrally be discriminated from reflected light. Though the following description concentrates on the measurement of reflected light, the principles discussed here can mutatis mutandis be applied to the detection of fluorescence, too.

The described microelectronic sensor device applies optical means for the detection of magnetic particles 1 and the target components one is actually interested in. For eliminating or at least minimizing the influence of background (e.g. of the sample fluid, such as saliva, blood, etc.), the detection technique should be surface-specific. As indicated above, this is achieved by using the principle of frustrated total internal reflection (FTIR). This principle is based on the fact that an evanescent wave propagates (exponentially dropping) into the sample 2 when the incident light beam L1 or a TIR-beam of n-th order is totally internally reflected. If this evanescent wave then interacts with another medium like the magnetic particles 1, part of the input light will be coupled into the sample fluid (this is called “frustrated total internal reflection”), and the reflected intensity will be reduced (while the reflected intensity will be 100% for a clean interface and no interaction). Depending on the amount of disturbance, i.e. the amount of magnetic beads on or very near (within about 200 nm) to the TIR surface (not in the rest of the sample chamber 2), the reflected intensity will drop accordingly. This intensity drop is a direct measure for the amount of bonded magnetic beads 1, and therefore for the concentration of target molecules. When the mentioned interaction distance of the evanescent wave of about 200 nm is compared with the typical dimensions of anti-bodies, target molecules and magnetic beads, it is clear that the influence of the background will be minimal. Larger wavelengths λ will increase the interaction distance, but the influence of the background liquid will still be very small.

The described procedure is independent of applied magnetic fields. This allows real-time optical monitoring of preparation, measurement and washing steps. The monitored signals can also be used to control the measurement or the individual process steps.

For the materials of a typical application, medium A of the carrier 111 can be glass and/or some transparent plastic with a typical refractive index of 1.52. Medium B in the sample chamber 2 will be water-based and have a refractive index close to 1.3. This corresponds to a critical angle θ_{c} of 60°. An angle of incidence of 70° is therefore a practical choice to allow fluid media with a somewhat larger refractive index (assuming n_{A}=1.52, n_{B} is allowed up to a maximum of 1.43). Higher values of n_{B} would require a larger n_{A} and/or larger angles of incidence.

Advantages of the described optical read-out combined with magnetic labels for actuation are the following:
Cheap cartridge: The carrier 111 can consist of a relatively simple, injection-molded piece of polymer material.
Large multiplexing possibilities for multi-analyte testing: The binding surface 112 in a disposable cartridge can be optically scanned over a large area. Alternatively, large-area imaging is possible allowing a large detection array. Such an array (located on an optical transparent surface) can be made by e.g. ink jet printing of different binding molecules on the optical surface. The method also enables high-throughput testing in well-plates by using multiple beams and multiple detectors and multiple actuation magnets (either mechanically moved or electro-magnetically actuated).
Actuation and sensing are orthogonal: Magnetic actuation of the magnetic particles (by large magnetic fields and magnetic field gradients) does not influence the sensing process. The optical method therefore allows a continuous monitoring of the signal during actuation. This provides a lot of insights into the assay process and it allows easy kinetic detection methods based on signal slopes.
The system is really surface sensitive due to the exponentially decreasing evanescent field.
Easy interface: No electrical interconnect between cartridge and reader is necessary. An optical window is the only requirement to probe the cartridge. A contact-less read-out can therefore be performed.
Low-noise read-out is possible.

In applications like blood testing, near-patient testing, or home testing, an extraordinarily high sensitivity may be required. In each total internal reflection of the input light beam L1 or a TIR-beam of n-th order (L_{TIR}⁽¹⁾ in FIG. 1), the detection signal is directly related to the ratio

1−α=Iₙ₊₁Iₙ,

with Iₙ being the incident intensity, Iₙ₊₁ the reflected intensity (of the TIR-beam of (n+1)-th order), and α being the loss factor due to frustration of the TIR at the binding surface because of the presence of e.g. beads 1 very close to the surface. Since a may be very small, Iₙ and Iₙ₊₁ can be very close, which makes accurate measurements more difficult (small change on a large signal).

As illustrated in FIG. 1, this problem is solved by letting the same light beam undergo multiple FTIR reflections at the same binding surface (but not necessarily in the same investigation region). In this way, the signal Iₒᵤₜ in the output light beam L2 will be given by the following formula:

Iₒᵤₜ=Iᵢₙ·(1−α)^{N+1}R^{N},

where (N+1) indicates the number of FTIR reflections at the binding surface and N the number of specular reflections at the reflective surface 114, respectively, Iᵢₙ is the intensity of the input light beam L1, and R is the reflectivity of the reflective surface 114.

The effect of multiple reflections (N≧1) is illustrated in the following table (for R=0.99):

| | Iₒᵤₜ/Iᵢₙ | Iₒᵤₜ/Iᵢₙ |
|---|---|---|
| α | (N = 4) | (N = 0) |
| 0.0001 | 0.960 | 1.000 |
| 0.001 | 0.956 | 0.999 |
| 0.01 | 0.914 | 0.990 |
| 0.1 | 0.567 | 0.900 |
| 0.2 | 0.315 | 0.800 |

Clearly, the sensitivity is much improved compared to the case of just a single total internal reflection, i.e. N=0 (larger signal change for a small change in cc). For the same signal-to-noise ratio (SNR), i.e. the variation in Iₒᵤₜ/Iᵢₙ due to noise, much smaller values of α can still be accurately determined, significantly increasing the dynamic range of the measurement method.

Fabricating appropriate carrier structures and applying a mirror coating is quite straightforward: the required spatial resolution of the mirror is not critical, so that a simple shadow mask is sufficient (no need for lithography) in combination with e.g. sputter deposition of a reflecting layer 114. Requirements on reflectivity are not strict. Higher reflectivities are preferred to avoid large losses of light, but R values larger than 0.9 are more than sufficient and easily reached (e.g. by a thin layer of 50 nm silver or copper).

The configuration of FIG. 1 with a reflective bottom surface 114 usually leads to large distances between the investigation regions 113.1, 113.2, . . . : Due to the TIR requirements on the angle of incidence, the minimum distance is (much) larger than the thickness of carrier 111, which is typically several hundred μm. Typical distances between the investigation regions can thus easily be around 1 mm. This leads to issues with a compact carrier design. Moreover, investigation regions should ideally be identical to benefit from a ‘multiplication’ effect. Large distances can thus lead to potential problems with e.g. uniformity. Finally, problems may arise for multiplexing configurations for e.g. multi-analyte applications.

In contrast to this, FIGS. 2 to 6 illustrate various embodiments of a carrier with reflections at side faces or facets. With these configurations, very close spacing of investigation regions is possible (mainly determined by the chosen angle of the input light beam), solving the mentioned disadvantages.

Thus FIG. 2 shows a first embodiment of a carrier 211 with the shape of a “dovetail prism”, i.e. a cuboid with two opposing side faces being slanted at an acute angle with respect to the binding surface 212. The design corresponds to the case of N=1 (i.e. one specular reflection, two FTIRs), with only (part of) one side facet 214 being reflectively coated. An input light beam L1 entering through the entrance window 215 is a first time totally internally reflected in a first investigation region 213.1 at the binding surface 212, once reflected at the reflective facet 214, a second time totally internally reflected in a second investigation region 213.2 at the binding surface 212, and emitted through an exit window 216 (on the same side face as the entrance window) as an output light beam L2.

For carriers with at least two specular reflections, i.e. N≧2, a part of two sides needs to be made reflective. Thus FIG. 3 shows a “dovetail” carrier 311 with reflective facets 314a, 314b on two opposite slanted sides next to an entrance window 315 and an exit window 316, respectively. For the shown particular geometry, the light entering as an input light beam L1 is two-times reflected on each reflective facet 314a and 314b, thus corresponding to the case N=4 and yielding five FTIR reflections in investigation regions 313.1 to 313.5 at the binding surface 312.

As a comparison of FIGS. 2 and 3 shows, light source and light detector can be positioned on the same side of the carrier for odd values of N, while they are positioned on opposite sides for even values of N.

FIG. 4 shows a carrier 411 (which may actually be identical to the carrier 311 of FIG. 3) which is used with multiple beams and/or multiple light detectors.

Alternative structures can be used as well instead of the described dovetail prisms. Examples are e.g. a cylinder lens (hemispherical cross-section) or a truncated pyramid (with four slanted side faces). The latter design is illustrated in FIGS. 5 and 6. In particular, FIG. 5 shows for N=3 a carrier 511 with three reflective facets 514a, 514b, 514c on neighboring slanted sides, yielding an U-shaped arrangement with the input light beam(s) L1 entering and the output light beam(s) L2 leaving through the uncoated side.

In FIG. 6, the carrier 611 is oblong, allowing for the input light beam L1 and output light beam L2 being parallel and thus a more compact design. Moreover, the fourth side comprises a reflective facet 614d, too, allowing for a total of N=8 specular reflections.

Besides side facet reflection, also the bottom surface of a carrier can be made reflective (cf. FIG. 1) to generate multiple reflections. This requires that this surface is also made very smooth and provided with a reflecting surface. This approach allows the structure to be made thinner, especially near the detection surface. Advantages are even lower material costs, and that the magnet/coil can be brought closer to the sample chamber, relaxing requirements on magnetic field strength.

It should be noted that the angle of incidence of the input light beam on the entrance window is shown to be at least near 90°. A larger angle of incidence with respect to the normal of the entrance window leads to a reduced coupling efficiency (a larger part of the light is reflected off the side facet and does not enter the carrier). As long as these reflections are shielded from the detector, or are compensated in a background measurement, this is not an issue, since the amount of light (LED or laser) power is not critical.

An exemplary design of the optical structure on the surface of the carrier 111-611 is shown in more detail in FIG. 7. This optical structure consists of wedges 51 with a triangular cross section which extend in y-direction, i.e. perpendicular to the drawing plane. The wedges 51 are repeated in a regular pattern in x-direction and encompass between them triangular grooves 52.

When the input light beam L1 (or, more precisely, a sub-beam of the whole input light beam L1) impinges from the carrier side onto an “excitation facet” 53 of a wedge 51, it will be refracted into the adjacent groove 52 of the sample chamber 2. Within the groove 52, the light propagates until it impinges onto an oppositely slanted “collection facet” 54 of the neighboring wedge. Here the input light that was not absorbed, scattered, or otherwise lost on its way through the sample chamber 2 is re-collected into the output light beam L2. Obviously the amount of light in the output light beam L2 is inversely correlated to the concentration of particles 1 in the grooves 52 of the sample chamber 2.

As a result a thin sheet of light is propagating along the contact surface, wherein the thickness of this sheet is determined by the wedge geometry and the pitch p (distance in x-direction) of the wedges. A further advantage of the design is that illumination and detection can both be performed at the non-fluidics side of the carrier.

Given the refractive index n₁ of the carrier (e.g. made of plastic), the refractive index n₂ of the (bio-)fluid in the sample chamber 2, and the entrance angle i of the input light beam L1, the wedge geometry can be optimized such that (i) a maximum amount of light is refracted back towards the light detector; and (ii) a maximum surface area is probed by the “reflected” light beam in order to have optimum binding statistics (biochemistry).

In case of a symmetrical wedge structure the refracted ray in the groove 52 between two wedges 51, sensing refractive index n₂, should be parallel to the optical interface. With respect to the variables defined in FIG. 7, this means that

o=α.

Furthermore, in order to have a maximum “clear” aperture for the incoming input light beam, the angle α of the wedge structure should be equal to the entrance angle i of the input light beam:

i=α.

Introducing these two demands into the law of refraction,

n₁·sin(i−90°+α)=n₂·sin(o)

implies after some calculations that

$$sin ( α ) = \frac{{n}_{2}}{4 {n}_{1}} \pm \frac{1}{2} \sqrt{{( \frac{{n}_{2}}{2 {n}_{1}} )}^{2} + 2}$$

For a plastic substrate with a refractive index n₁=1.6, and a water-like liquid with a refractive index of n₂ somewhere between 1.3 and 1.4, the optimum wedge angle α ranges between about 70° and 74°. An appropriate value for the pitch p of the wedges 51 is about 10 μm, giving a sample volume height of about 1.5 μm.

While the invention was described above with reference to particular embodiments, various modifications and extensions are possible, for example:
In addition to molecular assays, also larger moieties can be detected with sensor devices according to the invention, e.g. cells, viruses, or fractions of cells or viruses, tissue extract, etc.
The detection can occur with or without scanning of the sensor element with respect to the sensor surface.
Measurement data can be derived as an end-point measurement, as well as by recording signals kinetically or intermittently.
The particles serving as labels can be detected directly by the sensing method. As well, the particles can be further processed prior to detection. An example of further processing is that materials are added or that the (bio)chemical or physical properties of the label are modified to facilitate detection.
The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink jet printing on the optical substrate.
The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).
The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic sensor device for optical examinations at the binding surface (112) of a carrier (111-611), particularly for the detection of target components comprising label particles (1), comprising
a) a light source (21) for emitting an input light beam (L1) towards the binding surface (112), from which said beam is totally internally reflected as a “TIR-beam of first order” (L_{TIR}⁽¹⁾);
b) a “mirroring system” for redirecting a TIR-beam of n-th order (L_{TIR}⁽¹⁾) towards the binding surface (112), from which said beam is totally internally reflected as a “TIR-beam of (n+1)-th order” (L_{TIR}⁽²⁾), with n=1, . . . N for a given natural number N;
c) a light detector (31) for detecting an output light beam (L2) which comprises light of the TIR-beam of (N+1)-th order.

2. The microelectronic sensor device according to claim 1,
characterized in that the input light beam (L1) and the TIR-beams of n-th order (L_{TIR}⁽¹⁾), 1≦n≦N, are totally internally reflected in at least one investigation region (113.1, 113.2) at the binding surface (112) under similar conditions, particularly a similar chemical environment.

3. The microelectronic sensor device according to claim 1,
characterized in that it comprises an evaluation module (32) for determining the amount of target components comprising label particles (1) at the binding surface (112) from the detected output light beam (L2).

4. The microelectronic sensor device according to claim 1,
characterized in that the light source (21) is adapted to provide a plurality of input light beams (L1), preferably input light beams (L1) that propagate substantially in parallel.

5. A carrier (111-611) for optical examinations, particularly a carrier (111-611) for a microelectronic sensor device according to claim 1, comprising
a) an “entrance window” (115) through which an input light beam (L1) can enter the carrier (111-611);
b) a binding surface (112) at which the input light beam (L1) can be totally internally reflected as a “TIR-beam of first order” (L_{TIR}⁽¹⁾);
c) an at least partially reflective facet (114-614) from which a TIR-beam of n-th order (L_{TIR}⁽¹⁾) is redirected to the binding surface (112), where said beam is totally internally reflected as a “TIR-beam of (n+1)-th order” (L_{TIR}⁽²⁾), with 1≦n≦N for a given natural number N;
d) an “exit window” (116) through which an output light beam (L2) comprising light of the TIR-beam of (N+1)-th order can leave the carrier.

6. The carrier (211-611) according to claim 5,
characterized in that it comprises at least one facet (214-614) that is slanted at an acute angle with respect to the binding surface (112) and that is at least partially reflective.

7. The microelectronic sensor device according to claim 1,
characterized in that the carrier comprises two such slanted facets (314a-314d) on opposite sides of the carrier.

8. The microelectronic sensor device or the carrier (511-611) according to claim 6,
characterized in that it comprises three such slanted facets (514a-514d) arranged in an U-shape.

9. The microelectronic sensor device or the carrier (611) according to claim 6,
characterized in that it comprises four such slanted facets (614a-614d) arranged as a rectangle, wherein at least one of the facets lies adjacent to the entrance window (614) and the exit window (615).

10. The microelectronic sensor device according to claim 1,
characterized in that the carrier (111-611) comprises at least one hole or groove (52) in the surface of the carrier (111-611), whereby the hole or groove (52) has a cross section with two oppositely slanted opposing facets (53, 54), particularly a triangular cross section.

11. A method for optical examinations at the binding surface (112) of a carrier (111-611), particularly for the detection of target components comprising label particles (1), comprising
a) emitting an input light beam (L1) towards the binding surface (112), from which said beam is totally internally reflected as a “TIR-beam of first order” (L_{TIR}⁽¹⁾);
b) redirecting a TIR-beam of n-th order (L_{TIR}⁽¹⁾) towards the binding surface (112), from which said beam is totally internally reflected as a “TIR-beam of (n+1)-th order” (L_{TIR}⁽²⁾), with n=1, . . . N for a given natural number N;
c) detecting an output light beam (L2) which comprises light of the TIR-beam of (N+1)-th order.
